(19) United States
(12) Patent Application Publication
(10) Pub. No.: US 2004/0187700 A1
(43) Pub. Date: Sep. 30, 2004

(54) Method and apparatus for accelerating steam in a steam oven

(76) Inventor: Robert T. Tippmann, Fort Wayne, IN (US)

Correspondence Address: BAKER & DANIELS, 111 E. WAYNE STREET, SUITE 800, FORT WAYNE, IN, 46802

(21) Appl. No.: 10/808,954

(22) Filed: Mar. 25, 2004

Related U.S. Application Data
(60) Provisional application No. 60/457,633, filed on Mar. 26, 2003.

(51) Int. Cl. A47J 37/12

(52) U.S. Cl. 99/410

(57) ABSTRACT

A method and apparatus for accelerating steam in a steam oven. The steam acceleration of the present invention is sufficient to circulate steam throughout the cooking chamber of a steam oven and substantially eliminate stagnant noncondensible gases therein.

### CROSS-REFERENCE TO RELATED APPLICATION

This nonprovisional patent application claims priority under 35 U.S.C. §119(e) to co-pending U.S. provisional patent application serial No. 60/457,633 filed Mar. 26, 2003, the disclosure of which is hereby incorporated herein by reference.

### BACKGROUND OF THE INVENTION

1. Field of the Invention

The present invention relates to a steam oven for cooking food products, holding cooked food products at a desirable temperature, or thawing food products. More particularly, the present invention relates to a method and apparatus for accelerating steam in a steam oven.

2. Description of the Related Art

Steam ovens utilize steam to heat food products placed in the oven. The steam can cook the food products and can also maintain cooked food products at a desirable temperature. The food products are heated when steam in the cooking chamber condenses on the food products held therein. Condensing of steam on the food products causes heat transfer to occur to thereby heat the food products. In addition to steam, the heating chamber of a steam oven also includes noncondesible gas. Generally, the noncondensible gas in a steam oven is air. It is undesirable to have a large amount of noncondensible gas in a steam oven because the noncondensible gas can act as an insulator and prevent the steam in the cooking chamber from contacting the food products positioned therein. When noncondensible gas insulates food products, the heating process of the steam oven is impeded.

Steam ovens necessarily include a source of steam for providing steam to the cooking chamber. Certain steam ovens provide a reservoir of water positioned in the bottom of the oven which is manually filled with water which is heated to create steam in the oven. Such a steam oven is commonly referred to as a “connectionless” oven. One such connectionless steam oven is the STEAM ‘N’ HOLD steam oven available from AccuTemp products, Inc. of Fort Wayne, Ind. Alternative steam ovens utilize a water supply line and a drain line to circulate water through the steam oven. The STEAM ‘N’ HOLD steam oven is unique in that it provides a vacuum pump for decreasing the pressure in the steam oven to allow the water contained therein to boil at a temperature of less than 212° F., i.e., the boiling point of water at atmospheric pressure. Certain steam ovens increase the pressure in the cooking chamber to create a pressure cooker to cook food products very rapidly. Finally, certain steam ovens include a cooking chamber which is maintained at ambient pressure.

In the case of a low pressure steam oven such as the STEAM ‘N HOLD, a vacuum port fluidly connects the cooking chamber and a vacuum pump. The vacuum pump is activated to pull a vacuum on the cooking chamber and reduce the pressure of the cooking chamber to below ambient pressure. The vacuum pump operates to remove both noncondensible gas and steam from the cooking chamber. In a steam oven operating at or above ambient pressure, a vent allows for removal of noncondensible gas from the cooking chamber. In a steam oven operating at ambient pressure, the cooking chamber is vented to atmosphere so that the pressure in the cooking chamber is not greater than atmospheric pressure. In a steam oven operating above ambient pressure, the vent operates to retain the desired pressure in the cooking chamber.

In all steam ovens, noncondensible gases can become stagnant within the cooking chamber. When this happens, the noncondensible gases are not vented and can insulate the food products contained in the cooking chamber and inhibit heating of the food products as described above. For example, noncondensible gases can become trapped between adjacent food trays. In typical steam ovens, water is heated in an open topped reservoir formed in the bottom of the cooking chamber to produce steam which rises from the bottom of the cooking chamber to reach the food products positioned therein. If the cooking chamber is filled with food trays, the flow of steam from the bottom of the cooking chamber to the top thereof is impeded and the problem of stagnant noncondensible gases can be exacerbated.

### SUMMARY OF THE INVENTION

The present invention accelerates steam in a steam oven to substantially eliminate stagnant noncondensible gases in the oven.

One exemplary embodiment of the invention comprises a conduit having a tapered passage positioned intermediate to and in fluid communication with a source of steam and a cooking chamber of a steam oven. The source of the steam can be internal or external to the oven. Steam produced by the source of steam traverses the tapered passage as it travels from the source of steam to the cooking chamber. Owing to the progressively decreasing size of the tapered passage, the steam accelerates as it traverses the passage based on the Venturi effect.

In another exemplary embodiment, a steam circulation cover is positioned intermediate the water reservoir and cooking chamber of a steam oven. The cover forms a headspace above a quantity of water in the water reservoir. A heating element is used to boil the quantity of water to produce a quantity of steam which accumulates in the headspace. The cover directs the steam in the headspace to a tapered passage which fluidly connects the water reservoir and the cooking chamber. Owing to a progressively decreasing size of the tapered passage, steam is accelerated as it traverses the tapered passage based on the Venturi effect. This steam acceleration is sufficient to cause a circulating steam flow throughout the cooking chamber that substantially eliminates stagnant noncondensible gases.

In one exemplary embodiment utilizing a steam circulation cover, the cover includes a top panel slightly smaller in size than a conventional water reservoir used in a steam oven. Three substantially vertical panels extend downwardly from the top panel. A first substantially vertical panel extends from a front edge of the top panel, a second substantially vertical panel extends from a rear edge of the top panel, and a third substantially vertical panel extends from a side edge of the top panel. In this embodiment, the steam circulation cover further includes an exit panel extending upwardly from the top panel. The exit panel typically forms an angle of greater than 90° with the top panel and cooperates with an interior wall of the cooking chamber to create the tapered passage through which steam exits the water reservoir.

In another embodiment utilizing a steam circulation cover, the top panel comprises two substantially co-planar top panels each having an exit panel extending therefrom. The exit panels extend from the top panels and cooperate to form a tapered passage. In this embodiment, the steam circulation cover includes a second substantially vertical side panel extending downwardly from the side of the top panel opposite the first side panel so that all four sides of the top panel include a downwardly extending panel connected thereto. In one such embodiment of the present invention, a first exit panel extends downwardly from a first top panel, a second exit panel extends upwardly from a second top panel, and the first and second exit panels overlap and form the tapered passage through which steam exits the water reservoir. In certain embodiments of the present invention utilizing a steam circulation cover having a pair of top panels, the top panels may be conjoined by a connecting panel. The connecting panel may comprise one of the substantially vertical panels described above. In one exemplary embodiment, the connecting panel extends downwardly from the top panels to support the top panels above the water reservoir. The steam circulation cover may also comprise discrete top panels which are not conjoined and which are individually supported above the water reservoir. If the top panels are not conjoined, they can be manipulated individually to control the size of the tapered passage.

In a further alternative embodiment, the steam circulation cover does not include one or more exit panels as described above, but rather includes a top panel having a plurality of apertures. In this embodiment, a plurality of projections having tapering apertures extend from the top panel, with the tapering aperture of each projection in fluid communication with an aperture in the top panel.

The invention, in one form thereof, comprises an oven including an interior wall forming a cooking chamber; a source of steam in fluid communication with the cooking chamber, whereby the source of steam provides a quantity of steam to the cooking chamber; and a conduit having a tapered passage positioned intermediate the source of steam and a cooking chamber, whereby the quantity of steam traverses the tapered passage to enter the cooking chamber.

The invention, in another form thereof, comprises an oven including an interior wall forming a cooking chamber; a source of steam in fluid communication with the cooking chamber, whereby the source of steam provides a quantity of steam to the cooking chamber; and an acceleration means for accelerating the quantity of steam.

The invention, in yet another form thereof, comprises a method of accelerating steam in a cooking chamber of an oven comprising the steps of: providing a quantity of steam; transferring the quantity of steam to the cooking chamber; and accelerating the quantity of steam during the transferring step.

Advantageously, the present invention accelerates steam entering the cooking chamber of a steam oven to substantially eliminate stagnant noncondensible gases and promote efficient heat transfer to the food products contained within the steam oven.

### BRIEF DESCRIPTION OF THE DRAWINGS

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 is a front elevational view of a steam oven incorporating a first embodiment steam circulation cover of the present invention;

FIG. 2 is a perspective view of the steam circulation cover of FIG. 1;

FIG. 3 is a partial cross-sectional view of the first embodiment steam circulation cover of the present invention coooperating with an oven wall to form a tapered passage;

FIG. 4 is a perspective view of a second embodiment steam circulation cover in accordance with the present invention;

FIG. 5 is a cross-sectional view thereof;

FIG. 6 is a perspective view of a third embodiment steam circulation cover in accordance with the present invention;

FIG. 7 is a cross-sectional view thereof;

FIG. 8 is a partial cross-sectional view of the third embodiment steam circulation cover of the present invention;

FIG. 9 is a perspective view of a food tray rail useable with a steam oven; and

FIG. 10 is a perspective view of a food tray support useable with a steam oven.

### DETAILED DESCRIPTION OF THE INVENTION

FIG. 1 illustrates steam oven 15 including steam circulation cover 22 positioned therein. As illustrated in FIG. 1, steam oven 15 includes cooking chamber 11 enclosed by door 13. Door 13 is hingedly connected to steam oven 15 via hinges 12 and includes handle 14 for use in positioning door 13 in one of an open and a closed position. In the closed position, door 13 is hermetically sealed with the front face of steam oven 15 to enclose cooking chamber 11. As schematically illustrated in FIG. 1, steam oven 15 includes control panel 16 for controlling the operation of steam oven 15 in a conventional manner. In the embodiment illustrated, door 13 is transparent.

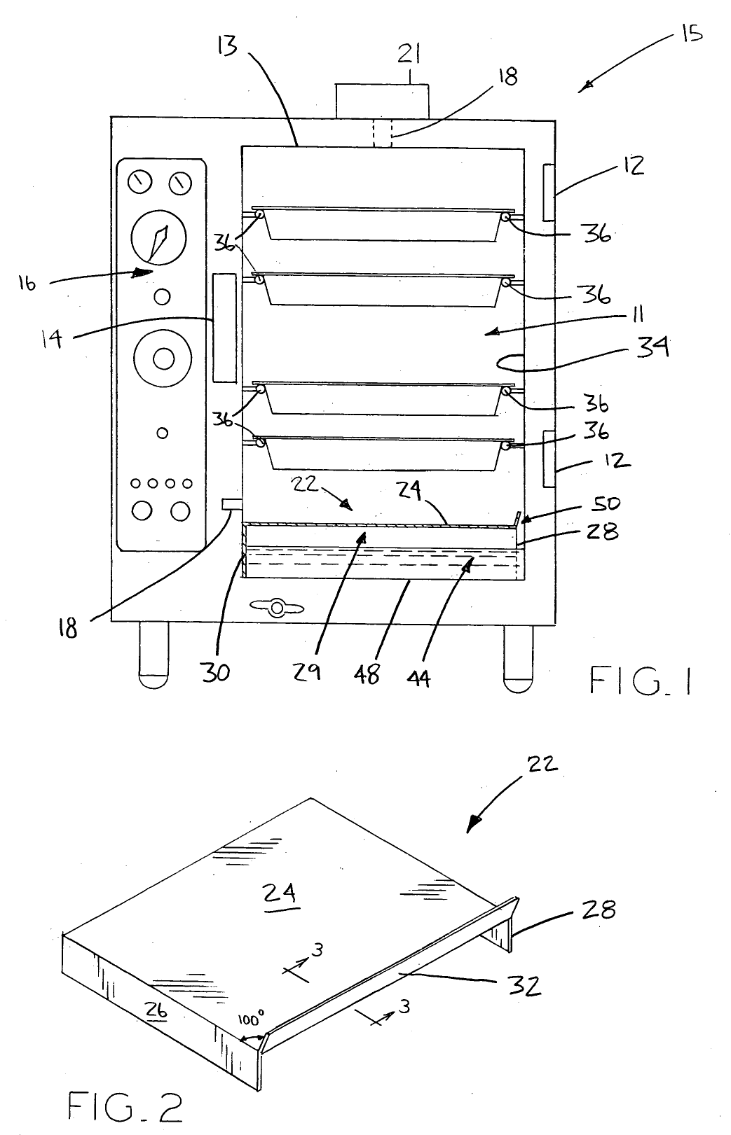

FIGS. 1, 2 and 3 illustrate steam circulation cover 22 in accordance with one embodiment of the present invention. Steam circulation cover 22 includes top panel 24, with front panel 26, rear panel 28, and side panel 30 extending substantially vertically therefrom. Front panel 26, rear panel 28, and side panel 30 cooperate to surround three of the four perimeter edges of top panel 24. Steam circulation cover 22 further includes exit panel 32. Exit panel 32 extends vertically upward from top panel 24 and forms an angle of about 100° therewith. Generally speaking, exit panel 32 will form an angle of greater than 90° with top panel 24 and can form any one of a number of fixed obtuse angles including the 100° angle illustrated in FIG. 2.

In use, steam circulation cover 22 is positioned within water reservoir 48 as illustrated in FIG. 1. With steam circulation cover 22 positioned within water reservoir 48, front panel 26, rear panel 28, and side panel 30 extend downwardly into water 44 positioned within water reservoir 48. Water 44 forms a seal with front panel 26, rear panel 28, and side panel 30 of steam circulation cover 22. A conventional heating element is utilized to heat water 44 and cause water 44 to boil. As water 44 boils, steam is collected in headspace 29. Steam collecting in headspace 29 primarily exits water reservoir 48 through tapered passage 50 formed by exit panel 32 and interior wall 34.

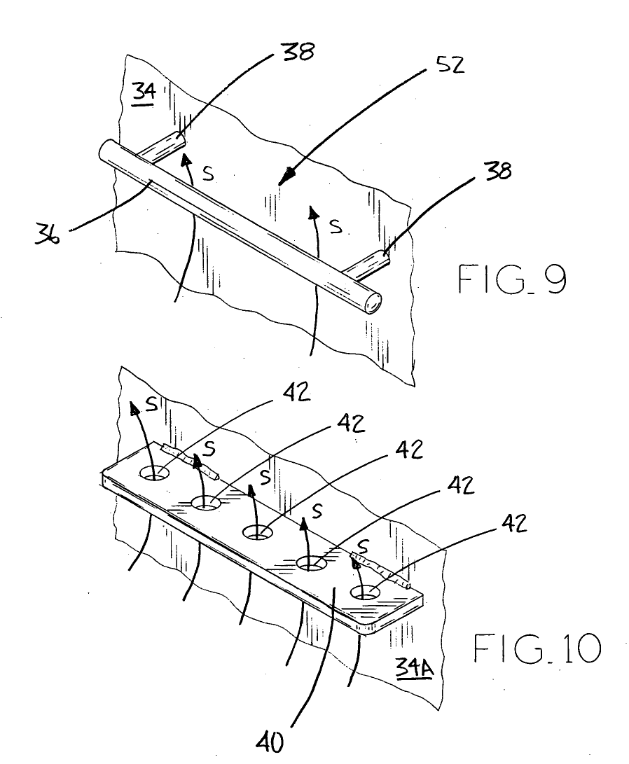

Because exit panel 32 forms an angle of greater than 90° with top panel 24 of steam circulation cover 22, tapered passage 50 formed by exit panel 32 and interior wall 34 will progressively decrease in size from a point closest to water reservoir 48 to a point furthest from water reservoir 48. This decrease in size creates a Venturi effect which accelerates the steam produced in headspace 29 as it exits water reservoir 48 through tapered passage 50. This steam acceleration is sufficient to cause a circulating steam flow throughout cooking chamber 11 that substantially eliminates stagnant non-commensible gases therein. Circulation of steam throughout cooking chamber 11 is facilitated by use of food tray rails 36 as illustrated in FIG. 1 and as illustrated in further detail in FIG. 9. As illustrated in FIG. 9, supports 38 are utilized to connect food tray rails 36 to cooking chamber wall 34 whereby open space 52 allows for steam flow S (FIG. 9) along cooking chamber wall 34.

In a further embodiment of the present invention steam flow S is allowed by utilizing food tray support 40 depicted in FIG. 10. As illustrated in FIG. 10, food tray support 40 is secured to cooking chamber wall 34A and includes a plurality of apertures 42 through which steam flow S can pass. Various alternative food tray rails or supports may be utilized in accordance with the present invention so long as steam flow S is allowed to pass by the periphery of the food trays positioned within the cooking chamber of the steam oven.

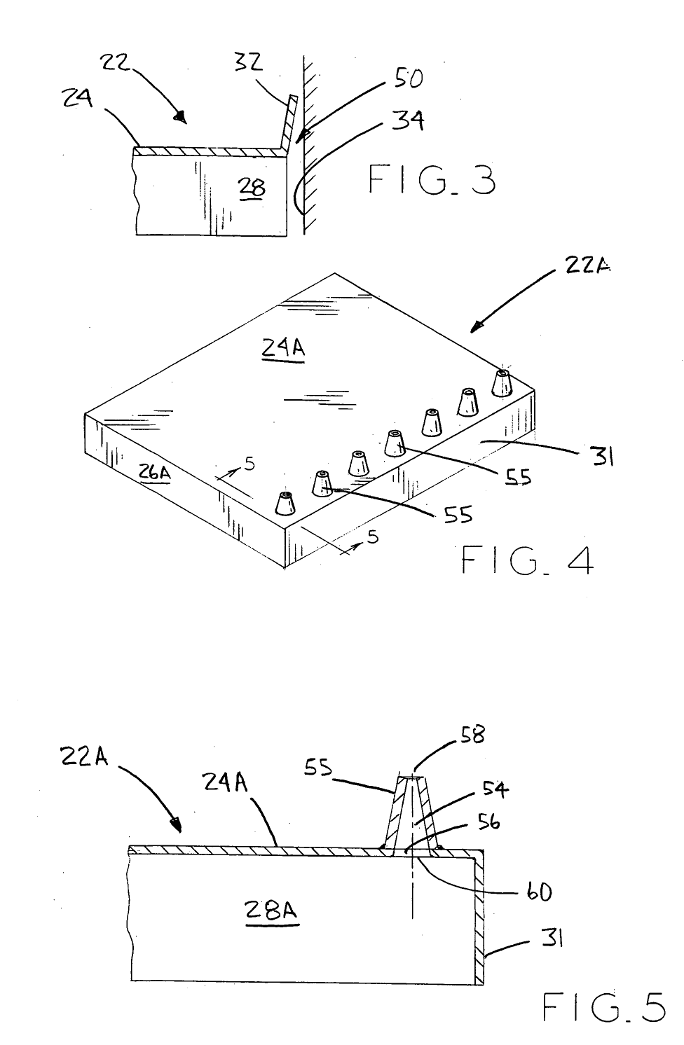

Various alternative embodiment steam circulation covers may be utilized in accordance with the teachings of the present invention, such as steam circulation cover 22A illustrated in FIGS. 4 and 5. As illustrated in FIG. 4, steam circulation cover 22A includes second side panel 31. Second side panel 31 and front panel 26A cooperate with a rear panel (not shown) and first side panel (not shown) to completely surround the periphery of top panel 24A. The rear panel and first side panel of steam circulation cover 22A are similar to rear panel 28 and first side panel 30 of steam circulation cover 22. When steam circulation cover 22A is positioned within water reservoir 48 (FIG. 1), steam formed in headspace 29 exits water reservoir 48 through tapered coaxial apertures 54 (FIG. 5) of projections 55 extending from top panel 24A. Steam is accelerated when it traverses tapered coaxial apertures 54, as entrances 56 (FIG. 5) of tapered coaxial apertures 54 are smaller than exits 58 (FIG. 5) thereof. Apertures 60 (FIG. 5) in top panel 24A are in fluid communication with headspace 29 and tapered coaxial apertures 54.

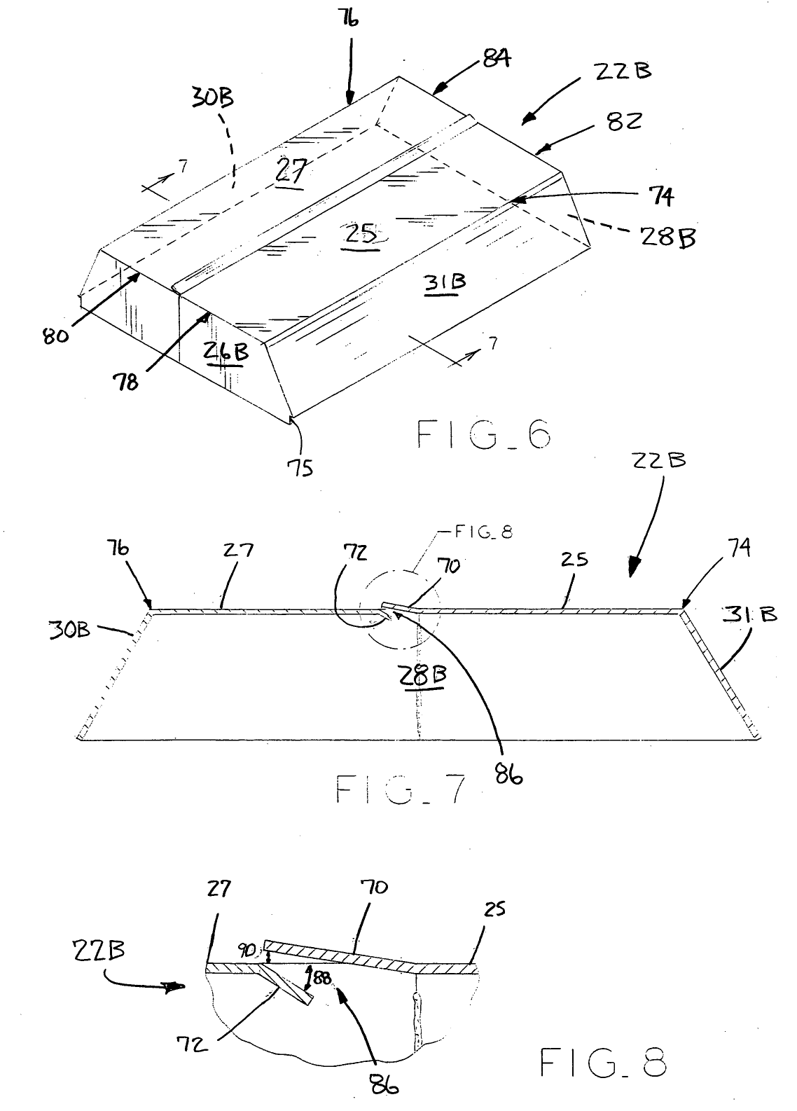

Another alternative embodiment of the steam circulation cover of the present invention is illustrated in FIGS. 6, 7 and 8. In this embodiment, steam circulation cover 22B comprises two substantially co-planar top panels 25 and 27, having exit panels. 70 and 72 (FIGS. 7 and 8), respectively. As illustrated in FIG. 6, side panel 31B extends downwardly from side edge 74 of top panel 25 and side panel 30B extends downwardly from side edge 76 of top panel 27. As illustrated, top panels 25 and 27 are conjoined by front panel 26B extending from front edges 78 and 80 of top panels 25 and 27, respectively. Top panels 25 and 27 are also conjoined by substantially vertical panel 28B extending from rear edges 82 and 84 of top panels 25 and 27, respectively. Front panel 26B, rear panel 28B, side panel 30B, and second side panel 31B completely surround the periphery of adjacent top panels 25 and 27. Water 44 forms a seal with front panel 26B, rear panel 28B, and side panel 30B of steam circulation cover 22B. In certain embodiments of the present invention, top panels 25 and 27 are not conjoined. In such arrangements, each top panel will include a structure for supporting the top panel above water 44 contained in water reservoir 48. The support structure of such an embodiment may include a series of downwardly extending panels similar to those illustrated in, e.g., FIG. 6. In this alternative embodiment, top panels 25 and 27 comprise discrete panels which are not conjoined and which can be manipulated individually to control the size of tapered passage 86.

As illustrated in FIGS. 7 and 8, adjacent exit panels 70 and 72 extend from top panels 25 and 27 and cooperate to form tapered passage 86. Steam in headspace 29 (FIG. 1) is directed to tapered passage 86 by steam circulation cover 22B. Steam is accelerated as it traverses tapered passage 86 and enters cooking chamber 11 (FIG. 1). Exit panel 72 extends downwardly from top panel 27 and exit panel 70 extends upwardly from top panel 25 and are arranged such that exit panels 70 and 72 overlap to create tapered passage 86. In the embodiment illustrated in FIG. 8, top panels 25 and 27 are substantially coplanar. In this exemplary embodiment, the magnitude of angle 88 that downwardly extending exit panel 72 forms with top panel 27 is greater than the magnitude of angle 90 that upwardly extending exit panel 70 forms with top panel 25.

When steam circulation insert 22B is positioned within water reservoir 48, tapered passage 86 is in fluid communication with headspace 29 and cooking chamber 11. Steam formed in headspace 29 will traverse tapered passage 86 to enter cooking chamber 11. The steam is accelerated as it traverses tapered passage 86 from headspace 29 into cooking chamber 11 based on the Venturi effect.

As illustrated in FIG. 6, tab 75 extends from front panel 26B. Tab 75 orients cover 22B in water reservoir 48 such that water 44 in water reservoir 48 may circulate under side panels 30B and 31 B from outside of the periphery of cover 22B. Tab 75 is preferable on covers that have downwardly extending panels surrounding the periphery of the top panel. As an alternative, other embodiments of a tab or another device may be used to permit the circulation of water in water reservoir 48.

As illustrated in FIG. 1, steam oven 15 includes vent 18. As steam is circulated through cooking chamber 11, noncondensible gases cannot remain stagnant and are brought into contact with vent 18 for removal from cooking chamber 11. In certain embodiments of the present invention, vent 18 may be connected to mechanism 21 for promoting airflow, such as a pump and/or a fan. As illustrated in FIG. 1, vent 18 is, in one exemplary embodiment, located in the bottom of cooking chamber 11 opposite tapered passage 50. With this location of vent 18, the steam flow through cooking chamber 11 can, advantageously, fully circulate through cooking chamber 11 before reaching vent 18. Preferably, steam circulation covers 22, 22A and 22B should be oriented in the oven such that the tapered passages of steam circulation covers 22, 22A and 22B are directed away from vent 18 so that the steam exiting the tapered passages may circulate through cooking chamber 11.

Steam circulation covers 22, 22A and 22B are generally formed of materials that are corrosion resistant, easily cleanable, and have sufficient weight to form an integral pressure relief valve such that if a sufficient pressure of steam were to build in headspace 29, this pressure would cause steam circulation covers 22, 22A and 22B to lift away from water reservoir 48 and release this pressure buildup. If desired, steam circulation covers 22, 22A, and 22B may be fixed within the oven. In these embodiments, the covers would not form the aforementioned integral pressure release valve.

Much of this detailed description has been directed to a steam oven having an internal water reservoir useable as a source of steam. The teachings of the present invention are not limited to such an embodiment and extend to any source of steam whether it be internal or external to the steam oven. For example, if an external source of steam is connected to the cooking chamber of a steam oven, a portion of the conduit connecting the source of steam to the steam chamber would be tapered to provide the steam acceleration desired by the present invention. In the embodiments discussed above, the conduit through which steam is conveyed to the cooking chamber is formed by the internal walls of the cooking chamber. That is, without one of the covers of the present invention, steam will simply rise from the water contained in the water reservoir and fill the cooking chamber. Covers 22, 22A and 22B of the present invention provide a tapered passage in that conduit and provide for the steam acceleration desired by the present invention.

While this invention has been described as having exemplary embodiments and scenarios, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An oven, comprising:
an interior wall forming a cooking chamber;
a source of steam in fluid communication with said cooking chamber, whereby said source of steam provides a quantity of steam to said cooking chamber; and
a conduit having a tapered passage positioned intermediate said source of steam and said cooking chamber, whereby said quantity of steam -traverses said tapered passage to enter said cooking chamber.

2. The oven of claim 1, wherein said source of steam comprises a water reservoir containing a quantity of water and a heating element for boiling said quantity of water, and wherein said oven further comprises a cover positioned intermediate said cooking chamber and said water reservoir, whereby said cover directs said quantity of steam to said conduit having a tapered passage.

3. The oven of claim 2, wherein said cover comprises:
a plurality of adjacent panels; and
an exit panel extending from each said adjacent panel, wherein said exit panels cooperate to form said tapered passage.

4. The oven of claim 3, wherein at least two of said plurality of adjacent panels are conjoined by a connecting panel extending from said at least two adjacent panels.

5. The oven of claim 2, wherein said cover comprises:
a panel; and
an exit panel extending from said panel, wherein said exit panel cooperates with said interior wall to form said tapered passage.

6. The oven of claim 2, wherein said cover comprises:
a panel having a panel aperture; and
a projection extending from said panel, said projection having a tapered aperture, wherein said panel aperture is in fluid communication with said tapered aperture, and wherein said tapered passage comprises said tapered aperture.

7. An oven, comprising:
an interior wall forming a cooking chamber;
a source of steam in fluid communication with said cooking chamber, whereby said source of steam provides a quantity of steam to said cooking chamber; and
an acceleration means for accelerating said quantity of steam.

8. The oven of claim 7, wherein said source of steam comprises:
a water reservoir containing a quantity of water; and
a heating element for boiling said quantity of water, and wherein said oven further comprises a cover positioned intermediate said cooking chamber and said water reservoir, whereby said cover directs said quantity of steam to said acceleration means.

9. The oven of claim 8, wherein said cover comprises:
a plurality of adjacent panels; and
an exit panel extending from each said adjacent panel, wherein said exit panels cooperate to form tapered passage, and wherein said acceleration means comprises said tapered passage.

10. The oven of claim 9, wherein at least two of said plurality of adjacent panels are conjoined by a connecting panel extending from said at least two adjacent panels.

11. The oven of claim 8, wherein said cover comprises:
a panel; and
an exit panel extending from said panel, wherein said exit panel cooperates with said interior wall to form a tapered passage, and wherein said acceleration means comprises said tapered passage.

12. The oven of claim 8, wherein said cover comprises:
a panel having a panel aperture; and
a projection extending from said panel, said projection having a tapered aperture, wherein said panel aperture is in fluid communication with said tapered aperture, and wherein said acceleration means comprises said tapered aperture.

13. A method of accelerating steam in a cooking chamber of an oven comprising the steps of:
providing a quantity of steam;
transferring said quantity of steam to the cooking chamber; and
accelerating said quantity of steam during said transferring step.

14. The method of claim 13, wherein said step of accelerating said quantity of steam comprises providing a conduit having a tapered passage in fluid communication with said quantity of steam and said cooking chamber.
